(19) United States
(12) Patent Application Publication
(10) Pub. No.: US 2016/0297696 A1
(43) Pub. Date: Oct. 13, 2016

(54) Appliances for the treatment of water

(71) Applicant: Paul Michael Pedersen, Upper Marlboro, MD (US)

(72) Inventor: Paul Michael Pedersen, Upper Marlboro, MD (US)

(21) Appl. No.: 14/545,255

(22) Filed: Apr. 13, 2015

(51) Int. Cl. C02F 1/66

(52) U.S. Cl. CPC C02F 1/66; C02F 2305/00

(57) ABSTRACT

The invention is directed to point of use devices and appliances for alkalizing and/or adjusting the oxidation/reduction potential of water that is to be ingested. The devices comprise straws, carafes, countertop units, water bottle units and any other devices that will treat the water at the point of use. The water will flow through the point of use devices or appliances longitudinally or radially. The point of use device or appliance will contain an alkalizing formulation that will increase the pH of the water to preferably above about 8 and the oxidation/reduction potential to about −100 and −700. The amount of water that can be treated will depend on the amount of the oxidation/reduction potential and alkalizing formulations used and the size and capacity of the device or appliance for the alkalizing and oxidation/reduction potential formulations. The alkalizing formulation will supply to the water being treated one or more of potassium, calcium and magnesium ions. The water prior to contacting the treatment compound can be filtered through a purification formulation to remove particulates, heavy metals and various organic compounds. The purification formulation can be a form of activated carbon.

This application is a continuation in part of U.S. application Ser. No. 12/998,138 filed Apr. 14, 2011, which is a continuation in part of provisional application 61/194,732 filed Sep. 30, 2008, the contents of each of which are incorporated herein by reference.

### BACKGROUND OF THE INVENTION

This invention relates to appliances for the reduction of the oxidation/reduction potential with or without the increase of the alkalinity of water. More particularly, the invention relates to point of use appliances for the reduction of the oxidation/reduction potential and additionally the increase of the alkalinity of water for subsequent personal use by a person.

It has been found to be a positive for a person's health to ingest water that has an alkaline pH and in particular that has an oxidation/reduction potential (ORP) of less than −100, and preferably less than about −300. Although the human stomach has an acidic pH of about 4.5 to 5.5 the blood of humans has a pH of about 7.4. This blood cell ph of 7.4 is supported by the bicarbonates produced in the body as a part of the digestive process. Foods are broken down by the hydrochloric acid generated in the stomach and in the lower intestine. This pH is about 4. As the hydrochloric acid is produced the bicarbonate is produced. The formation of bicarbonate is absorbed into the blood cell where it maintains the cell ph at about 7.4. As we age this process slows down and the resultant blood cell pH begins to lower. The ingestion of a high pH diet and/or liquid will cause the pH in the stomach to rise. The body compensates for the hydrochloric acid decrease by causing the stomach and the lower intestine to produce more hydrochloric acid and resulting bicarbonate. This additionally produced hydrochloric acid re-establishes the proper amount of hydrochloric acid needed for digestion and the additional bicarbonate helps to maintain the blood cell required pH of 7.4. The pH of drinking water is normally about 7. The process of food digestion utilizes hydrochloric acid, and depending on the food being digested other acids such as sulfuric acid and uric acid are produced in the stomach. As these acids are produced an equal amount of bicarbonates are also produced. These should be significantly neutralized. Then in order to maintain the blood pH at about 7.4 basic substances are needed. If not available from ingested substances the body will take calcium and potassium ions from parts of the body such as the skeletal structure. Rather than to have this occur, it is preferable to supply basic ions through foods and supplements. The ingestion of basic pH water will provide such ions. It also will throughout a day provide the base ions needed to assist in maintaining the blood pH at about 7.4.

The oxidation/reduction potential of municipal water is in the range of about +250 to about +400 depending on the content of minerals, salts, organics and chlorine or other added disinfectants. Water that is oxidizing is harmful over time to body tissues when ingested. It is needed to purify the water with regard to bacteria, viruses and other organics. However, an oxidizing atmosphere within the body will degrade such tissue over time. Such water will have preferably need to be modified to a reducing oxidation/reduction potential. It will need to be modified to an oxidation/reduction potential of abut −100 to about −700, and preferably to the range of from about −250 to about −400. This will result in better overall health. A reducing oxidation/reduction potential and an alkaline Ph will result in improved basic health.

An alkaline pH water can be provided by the addition of an alkaline supplement to the water that is to be ingested as is set forth in U.S. Pat. No. 5,306,511 and to an alkaline pill that can be ingested as is set forth in U.S. Pat. No. 5,914,130. In U.S. Pat. No. 5,306,511 that relates to the product AlkaLife, there is disclosed a concentrated alkaline solution of sodium hydroxide and potassium hydroxide. A sufficient amount is added to a glass of water to raise the pH of the water to be ingested to between 8 and 12. This will neutralize the stomach acids and promote a healthy pH to the blood. U.S. Pat. No. 5,914,130 is directed to a pill comprised of sodium bicarbonate and potassium bicarbonate that is ingested to neutralize stomach acids. This is a non-caustic formulation. One pill a day will replace the ingestion of many glasses of water provided under U.S. Pat. No. 5,306,511. Another way to provide for the ingestion of an alkaline water is to produce such water through electrolysis. The water is separated into an alkaline stream and an acid stream. The alkaline stream can be collected and used or stored for later use. Such a process is disclosed in U.S. Pat. No. 6,572,902.

A reducing oxidation/reduction potential is usually produced by treating water in ionizing equipment. Such ionizing equipment is available under the JPURE Ionizer, Jupiter Melody Water Ionizer and the Chanson Miracle Water Ionizer product names. Another way to produce water with a reducing oxidation/reduction potential is through contact with a substance that will lower the oxidation/reduction potential of the water. This water than can be consumed directly or it can be used to make a beverage such as coffee or tea or various drinks from a powder a fruit or vegetable source or in cocktails. This water also can be used for skin cleansing tooth brushing and consuming medications and vitamins.

The present invention provides a solution to this problem of water having an oxidation/reduction potential of −100 to −700 and the problem of providing water that has a reducing oxidation/reduction potential. There is provided a low cost point of use supply of a water that has an oxidation/reduction potential of −100 to −700 and also alkaline water that has a reducing oxidation/reduction potential of about −100 to −700. This is through the use of a formulation that will supply alkaline base ions to water that is flowed through such a formulation and reduce the oxidation/reduction potential when flowed through an ORP formulation to lower the ORP to less than −100. This alkaline formulation is a solid, substantially non-water soluble formulation that will supply one or more of sodium, potassium, calcium and magnesium ions to water that flows through the formulation. The alkaline formulation can contain a component that reduces the oxidation/reduction potential, or the formulation to reduce the oxidation/reduction potential can be in a separate layer to the alkaline formulation. In addition they can be in separate attached units. The formulation will be a part of an appliance such as a carafe filter, a straw, a water bottle unit that can alkalize and optionally purify a water at the time of ingestion, and a unit that is adjacent to a water source such as a counter top or under the sink unit for water treatment in a home, office school or business. All of these units will provide an alkalized water on demand by the treatment of the water with solid, substantially insoluble, formulation.

### BRIEF DESCRIPTION OF THE INVENTION

The invention is directed to an appliance for treating input water to increase the alkalinity and decrease the oxidation/reduction potential of the input water, the appliance comprising a housing containing one or more units, an input aperture for input water and an exit aperture for the flow of the input water from the housing for ingestion, a holder for an alkaline and oxidation/reduction potential formulation mounted in an alkalizing unit of the housing, one end of the housing connected to the input aperture and the other end of the holder connected to an exit aperture of the housing, the alkaline formulation being a solid and comprising at least one shaped structure containing compounds to raise the pH of the input water, the alkaline formulation containing ions of one or more of sodium, potassium, calcium and magnesium, the pH of the input water being increased at least about 0.5 pH. The oxidation/reduction potential formulation comprises a quantity of particulate magnesium metal. This will usually be in a layer of particulate magnesium metal or the particulate magnesium metal can be in an attached separate ORP unit. When in a separate unit it can be located before or after the alkaline unit.

The alkaline formulation can contain about 25% to about 80% by weight of the ions of one or more of sodium, potassium, calcium and magnesium. The alkaline formulation can have a calcium content of about 40% to 60% by weight of calcium ions in the form of their oxides and about 8% to about 20% by weight of magnesium ions in the form of their oxides and oxidation/reduction potential particulate magnesium metal in a quantity of about 3 percent to about 30 percent by weight of the alkaline formulations.

The alkaline formulation can be in the form of particles having a mean diameter of about 5 mm to about 50 mm or can be in a non-particulate three dimensional form. The input water has a pH of about 5 to 7.5, usually about 7. The alkaline formulation and oxidation/reduction potential formulation can treat a total volume of water of about 5 liters to about 10,000 liters depending on the appliance unit and the alkaline formulation content of the appliance unit. In a preferred embodiment the holder and formulation are replaceable. The full appliance unit need not be replaced.

The appliance unit can be a straw, the straw having a housing containing a unit, a dip tube extending from the lower input end of the housing and a straw segment extending from the exit end of the housing, whereby when a suction is applied to the straw segment water is drawn up through the dip tube into and through the housing and alkaline and oxidation/reduction potential formulation exiting into the straw segment. The appliance unit also can be a water bottle with a modified straw unit containing the alkaline formulation. By squeezing the bottle or through a sucking action on the bottle exit the water is drawn up through the modified straw and ingested.

The appliance unit can be a pour through unit such as a carafe attachment wherein the housing is an input funnel at the housing input end and disposed over a container at the housing output end whereby input water is fed into the funnel, passed downwardly through the unit in the housing, and flowed through the holder containing the formulations and into the container from the exit aperture of the housing.

The housing in one embodiment is a continuous longitudinal body except for the input aperture and the exit aperture with the water flowed longitudinally through the housing and the container alkaline and oxidation/reduction potential formulations from the input aperture to the exit aperture. In an alternative embodiment the holder is a longitudinal body with an exit aperture at one end and a plurality of small to micro apertures in the longitudinal body surface to allow water to be treated to flow radially into a holder for the alkaline formulation in the housing, through the alkaline and oxidation/reduction potential formulation and into a collector channel in the holder. The various appliances can utilize a longitudinal flow or a radial flow.

The holder in a further embodiment can contain a water purification formulation prior to the alkaline and oxidation/reduction potential formulations. The holder, purification formulation and alkaline and oxidation/reduction potential formulations are replaceable in the housing of the appliance.

In the embodiment where the unit is a straw, the housing will contain the purification formulation and the alkaline formulation and oxidation/reduction potential whereby when a suction is applied to the straw, water is drawn up through the dip tube into and through the holder and purification formulation and alkaline formulation and oxidation/reduction potential formulation exiting into the straw segment.

In the embodiment where the appliance unit is a carafe the housing is a funnel-like housing disposed over a container at the housing output end whereby input water is fed into the funnel, passed downwardly through the housing alkaline and oxidation/reduction potential formulations and/or purification formulation in the housing, and flowed into the container from the exit aperture of the housing.

In the embodiment where the housing is a continuous elongated body except for the input aperture and the exit aperture, the purification formulation and the alkaline treatment and oxidation/reduction potential formulations are layered longitudinally, the purification formulation layer being prior to the alkaline and oxidation/reduction potential treatment formulations.

In the embodiment where the housing has a holder for the purification formulation and the alkaline and oxidation/reduction potential formulations, the holder is an elongated structure with an outer wall and an internal channel, the channel closed adjacent the input aperture of the housing, and at least a portion of the outer wall having a plurality of pores to allow for the passage of water radially into the holder and into contact with the purification formulation and/or alkaline and oxidation/reduction potential formulations, and then into the internal channel to raise the pH of the water exiting the internal channel at the exit aperture of the housing.

The formulation is a solid that is substantially non-water soluble but which contains one or more sources of sodium, potassium, calcium and/or magnesium ions that can be dissolved into the water flowing through the alkaline formulation. The support for such ions is an alumina, aluminosilicate inclusive of zeolites, silica, titania or a clay. The support will have a particle density of about 0.9 to about 1.3 g/cc. The formulation will contain particulate magnesium metal for Ph and oxidation/reduction potential adjustment.

### BRIEF DESCRIPTION OF THE DRAWINGS

FIG. 1 is a cross-sectional view of an appliance unit housing containing a purification and an ORP formulation unit or an alkalizing formulation unit in a longitudinal arrangement.

FIG. 1a is a cross-sectional view of a holder cartridge that can be used in conjunction with the appliance unit of FIG. 1.

FIG. 2 is a cross-sectional view of an appliance unit and a holder containing an alkalizing and/or an oxidation/reduction potential formulation in a radial arrangement.

FIG. 2a is a cross-sectional view of an appliance unit and a holder containing a purification formulation and an alkalizing unit and/or oxidation/reduction potential formulation unit in a radial arrangement.

FIG. 3 is a cross-sectional view of a straw comprised of a combined housing and holder containing an alkalizing unit and/or oxidation/reduction potential formulation unit in a longitudinal arrangement.

FIG. 3a is a cross-sectional view of a straw comprised of a combined housing and holder containing a purification formulation and an alkalizing unit and/or oxidation/reduction potential formulation unit in a longitudinal arrangement.

FIG. 4 is a cross-sectional view of a carafe unit that has a combined housing and holder containing an alkalizing unit and/or oxidation/reduction potential formulation.

FIG. 4a is a cross-sectional view of a carafe unit along line 4a-4a of FIG. 5 that has a combined housing and holder containing a purification formulation and an alkalizing unit and/or oxidation/reduction potential formulation unit.

FIG. 5 is a top plan view of the carafe unit of FIG. 5.

### DETAILED DESCRIPTION OF THE INVENTION

The invention will now be described in more detail in its preferred embodiments with reference to the drawings. The described invention may be modified in various details but will still be within the concepts of the present invention.

It is known that alkaline water and water with an ORP of about −100 to about −700 have certain health benefits. In the present invention it has been found that the best way to provide water for human ingestion is to alkalize the water and adjust its ORP at the point and the time of use. It is not useful to treat all of the water for a household since in some uses about a neutral pH is needed or in some instances an acidic pH is needed. For instance the surface of the skin has a slightly acidic pH with a neutral to a slightly acidic water being useful. Further, if the water for a household is alkalized there can result scale problems in the piping and in the water heaters. This will be a negative. The most effective and efficient technique to provide an alkalized water is to alkalize the water at or adjacent to the point of use. Consequently, the present invention is directed to having the alkalizing formulation a part of appliances such as water bottles, straws, carafes, counter top units that supply water only for ingestion, water fountains, soda fountains, refrigerator ice making units and other point of use appliance units. This applies equally to treating the water so that it has an ORP of about −100 to about −700.

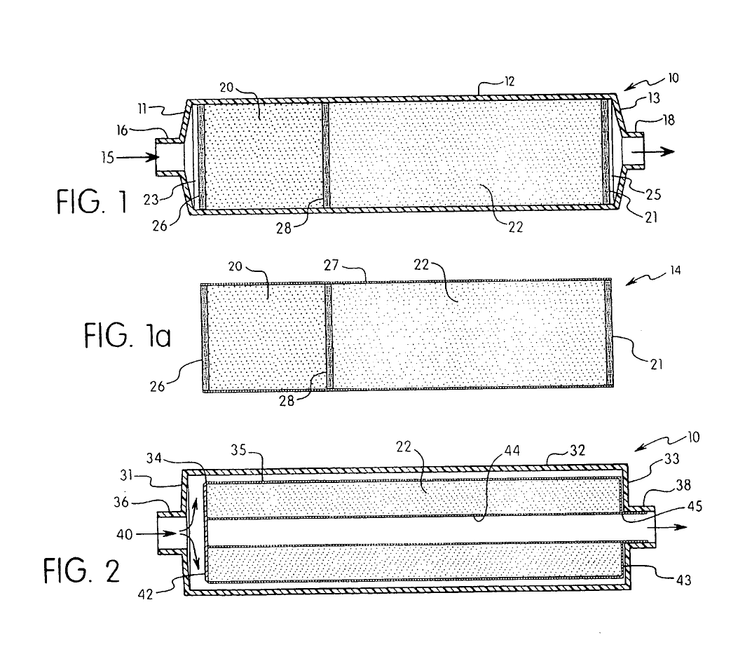

FIG. 1 sets out an appliance unit 10 that is adapted for linear flow of water that is to be alkalized or ORP adjusted in a longitudinal direction. The appliance unit 10 is comprised of continuous circumferential wall 12 with inlet end wall 11 and outlet end wall 13 which comprise the housing. In this embodiment the housing of the appliance unit substantially functions also as a holder for the purification formulation 20 and alkalizing or ORP formulation 22. In an additional embodiment the housing can solely contain the alkalizing unit or ORP formulation unit. Thus it will along with mesh 23 and mesh 25 hold the alkalizing or ORP adjusting formulation 22 and the purification formulation 20. Appliance unit end wall 11 has inlet 16 for the flow of water 15 into the appliance unit 10 and appliance unit end wall 13 has outlet 18 for the flow of purified and alkalized or ORP adjusted water to use from the appliance unit 10. There is a porous pad 26 adjacent the inlet 16 to maintain the purification formulation 20 in place and a porous pad 21 adjacent the outlet 18. The mesh 23 such as a screen supports porous pad 26 and the mesh 25 supports pad 21. There can be a porous pad 28 separating the purification formulation from the alkalizing unit or ORP adjusting formulation unit. Although it is preferred to have porous pad 28 this pad can be deleted if the purification formulation and the alkalizing or ORP adjusting formulation will remain substantially segregated without this separating pad 28. This appliance unit is used in different point of use. It can be used in counter top water treatment units, water fountains, soda fountains, and other appliance units for the production of purified and alkalized water. If only alkalized or ORP adjusted water is to be produced the purification formulation 20 can be deleted. It then will only contain the alkalizing or ORP adjusting formulation.

FIG. 1a is directed to a cartridge holder unit 14 that can be used as a refill unit for the housing of the appliance unit 10. It comprises a circumferential outer wall 27, and pads 26, 28 and 21 as discussed above with reference to FIG. 1. Meshes 23 and 25 as shown in FIG. 1 will be a removable part of the appliance unit 10 and can provide a circumferential water seal in the FIG. 1 and FIG. 1a embodiments. In this way water will not be able to bypass the alkalizing or ORP formulation 22 in FIG. 1, purification formulation 20, and the formulation 22 in FIG. 1a.

One preferred way to both alkalize the water and to adjust the ORP of the water to about −100 to about −700 is to utilize one appliance unit 10 with an alkalizing formulation and another appliance unit 10 with an ORP adjusting formulation connected in series. When connected in series usually the appliance unit with the alkalizing formulation will be the first unit and the ORP adjusting unit the second unit. In this arrangement the ORP adjusting unit will not contain a water purification formulation. The alkalized and ORP adjusted water will be delivered from exit 18 of the ORP

FIG. 2 is a appliance unit and housing unit that is related to that of FIG. 1 with the main difference being that in FIG. 2 the water flow through the holder 34 and the purification formulation 20 and/or alkalizing/ORP formulation 22 will be radial rather that longitudinal as shown in FIG. 1. In FIG. 2 the appliance unit 10 has a housing comprised of a circumferential wall 32 with end walls 31 and 33. End wall 31 has inlet aperture 36 for the input of water 40 into the housing and end wall 33 and alkalized or ORP water outlet 38. Within the appliance unit 10 is holder 34 with circumferential wall 35. There are end walls 42 and 43. The circumferential wall 35 is porous with apertures of from about 5 mm to about 40 mm. The apertures have a diameter less than the mean diameter of the particulate alkalizing formulation. The end walls 42 and 43 are solid, non-porous walls. Within the holder 34 is substantially porous channel 44 with apertures of from about 5 mm to about 40 mm. Part 45 of the porous channel 44 that is exposed to the input water is not porous but is continuous. These apertures have a diameter less than the mean diameter of the particulate alkalizing or ORP formulation. Optionally there can be a pad around porous channel 44. In this embodiment the input water flows into the appliance unit 10 through inlet 36 and is maintained between housing circumferential wall 32 and holder circumferential wall 35 until it flows through the apertures in holder circumferential wall 35 and into and through alkalizing media 22. After flowing through alkalizing or ORP media 22 the now alkalized or ORP treated water flows into porous channel 40 and to the exit at 38. This unit also can be used in counter top water treatment units, water fountains, soda fountains, and other appliance units for the production of purified and alkalized water.

FIG. 2a is directed to an appliance unit 10 and a holder 34 that can be used for the dual purpose of water purification and water alkalizing and/or ORP treating. In this embodiment the water purification formulation layer will be adjacent to the holder circumferential wall 35 with an inner layer of the alkalizing or ORP treating formulation 22. There is an outer purification layer 20 with a separating porous pad 39 between the two formulations if needed. The other parts are the same as in FIG. 2 and have been described in the description of FIG. 2. The difference from FIG. 1 is the use of a purification formulation 20 in conjunction with alkalizing or ORP treating formulation 22. In either the FIG. 2 embodiment or the FIG. 2a embodiment the holder 34 can be a replaceable cartridge. The water purification formulation can be a particulate material, a larger particle material or a continuous molded insert. All that is required is that the input water flow first pass through the purification formulation and then through the alkalizing or ORP treating formulation. The particular needs will dictate the physical forms of the purification formulation and the alkalizing and ORP treating formulation. When the alkalizing unit and the ORP decreasing units are connected, the exit of one to the input of the other the purification layer needs only to be in the first unit,

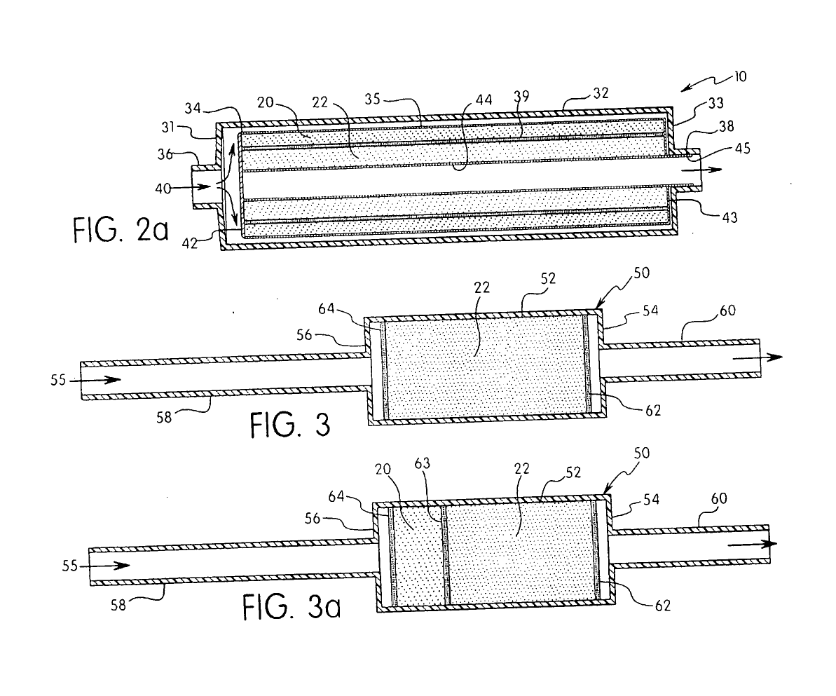

FIG. 3 is a cross-sectional view of a straw appliance unit 50 for the alkalizing or ORP treatment of water from a water bottle. A person can refill the bottle from a water tap, a fountain or from a large spring water bottle and have alkalized water by the drinking of the water via the straw appliance unit 50. The straw appliance 50 contains the alkalizing or ORP formulation 22. At the water input end of the alkalizing or ORP treating formulation there is a porous pad 64 and at the outlet end there is a porous pad 62. The function of the porous pads is to maintain the alkalizing or ORP treating formulation in place in the circumferential wall 52 of the straw appliance 50. The porous pads will have sufficient integrity so as to maintain their structure during use. The straw appliance unit 50 in addition to circumferential wall 52 has end wall 56 at the water input end and end wall 54 at the water exit end which collectively form the housing. Water 55 is supplied through straw dip tube 58 and by the applied suction of a person. It is drawn up through straw delivery tube 60 and into a person's mouth. The straw appliance unit 50 can be constructed to be disassembled so that replacement holder cartridges can be inserted and used as refills. In this way the housing, the dip tube and the delivery tube can be reused. However, in most instances the full straw will be replaced when the alkaline or ORP treating formulation has been depleted. The straw appliance parts are of a low cost which is similar to that of a cartridge unit.

The FIG. 3a shows the straw appliance unit 50 with both a purification portion and an alkalizing or ORP treating portion. There will be an alkalizing unit and an ORP decreasing unit. In this embodiment there will be a purification formulation 20 adjacent to inlet end wall 56. This end wall 56 and porous pad 64 will maintain the purification media in position. As a part of this structure there will be a porous pad 62 adjacent end wall 56. In addition this straw appliance unit 50 can be adapted for use as a replacement unit for a personal water bottle of the type used by individuals in warm climates and by runners and other athletes. The housing is then designed to be mounted in the neck of the bottle with the dip tube 58 extending down into the bottle. In addition although the straw appliance is shown with a longitudinal flow through the alkalizing formulation or ORP treating formulation, the flow can be radial. FIG. 2 and FIG. 2A show a radial flow.

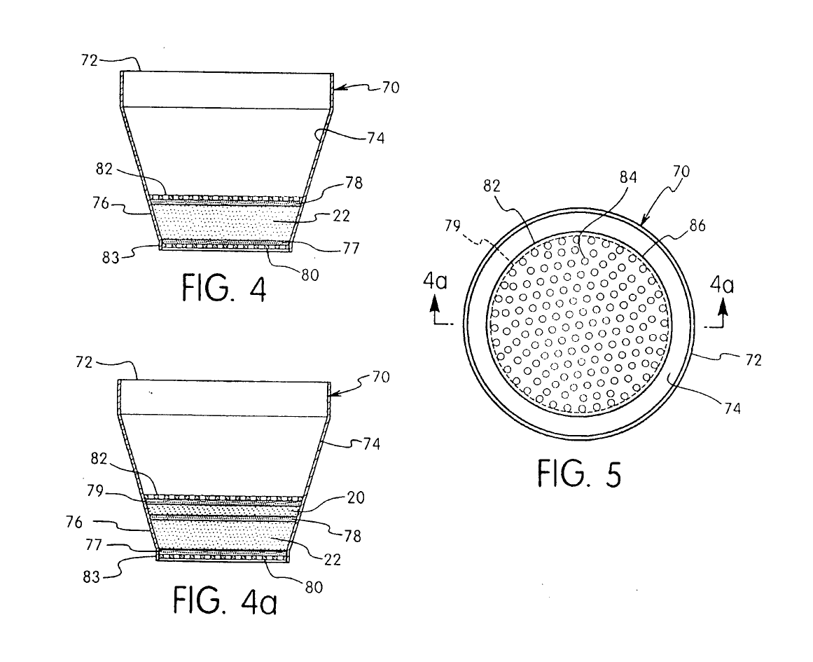

FIG. 4 is a cross-section view of the upper portion of a carafe filter unit 70. The carafe filter unit 70 has upper wall 72, and tapered wall 74 to a base area 76 which collectively form the housing. The carafe unit is open at the upper end. At the base area 76 there is a screen 80, a porous pad 77 above the screen and the alkalizing formulation or ORP treating formulation 22 above the porous pad 77. Above the formulation 22 there is a porous pad 78 and a mesh 82 for water to pass through after it enters into the carafe filter unit 70. FIG. 5 is a top plan view of carafe filter unit 70 of FIG. 4. This FIG. 5 shows the lower region 76 in more detail with the apertures 84 to allow the input water to pass into the tapered funnel part 74 of the carafe filter unit. The mesh 82 contacts the tapered wall 74 at 86. FIG. 4a is an embodiment of the carafe filter unit where there is a purification formulation and an alkalizing or ORP treating formulation. In this embodiment the structure is the same as that of FIG. 4 with the addition of a purification formulation 20 above the porous pad 78 with a porous pad 79 above the purification formulation 20. The mesh 82 is above the porous pad 79. The apertures will be from about 0.5 mm to about 40 mm in diameter. Commercially available screen material can be used. The pad will be of a structure to hold the alkalizing formulation in place, but be sufficiently porous to allow the water to readily pass through to the alkalizing formulation. If desired above the alkalizing or ORP treating formulation there can be a purification formulation. It can be of a particulate size or of a small pellet size. Also depending on the form of the purification formulation there can be a pad between the purification formulation and the alkalizing or ORP treating formulation. The various structural parts can be molded from various thermoplastics. Preferred thermoplastics are polyethylenes and polypropylenes.

The purification formulations that can be used in the present appliance units include the various activated carbons and other materials that will remove heavy metals and various organics from water. Very useful formulations are disclosed in U.S. Pat. No. 5,118,655. These can be in a particulate or molded three dimensional form. The useful alkalizing formulations are those that will supply alkaline ions such as sodium, potassium, calcium and magnesium ions to water that passes through the formulation. The One objective is to raise the pH of the water at least about 0.5 pH, and preferably above about 8.0. This must be accomplished relatively quickly as the water is passing through the alkalizing formulation. In this way it can effectively raise the pH of water to the desired level to make the various appliances practical in the raising the pH of water that is to be ingested. Another objective is to produce water with an ORP preferably between about −100 and about −700.

The alkalizing formulation will be comprised of a support for the sodium, potassium, calcium and magnesium ions. These ions must be extractable, leachable and/or exchangeable from the support over a period of time to raise the pH of the water flowing through the alkalizing formulation. The support will be a material such as an alumina, an aluminosilicates including zeolite aluminosilicates, a silica, a titania and/or a clay. The sodium, potassium, calcium and magnesium ions are held in the support physically and chemically. If the support will contain a zeolite the sodium, potassium, calcium and magnesium ions can be ion exchanged for other ions in the water. The requirement is that the sodium, potassium, calcium and magnesium ions must be leachable, extractable and/or exchangeable from the support. In addition they should leach a minor amount of aluminum and any higher atomic weight metals into the water. In general the supports can contain from about 25% to about 80% by weight of the sodium, potassium, calcium and magnesium ions as calculated as their oxides. The remaining content is the substantially inert base material. The alkalizing formulation need not contain all of these ions. However, it is preferred that it contain at least three of these ions. The preferred ions are those of calcium, magnesium and potassium. The formulation usually will be in a particle size of about 5 mm to about 50 mm, and a particle density of about 0.7 to about 1.7 gms/cc., preferably about 0.9 to about 1.25 gms/cc. However, other particle sizes can be used and the alkalizing formulation can be in the form of molded units that can be inserted into a holder and adapted to a particular use.

This alkaline formulation also can contain magnesium metal in the form of particulate magnesium. The magnesium metal, when utilized will be in a content of about 3% to about 30% by weight of the alkaline formulation. The particle size can be similar to that of the oxide base material for the calcium, potassium, sodium and magnesium ions. The particle size can also be greater or less than that of the oxide base material. In addition the magnesium can be in the form of various shaped particles including chips.

Although the base support material can be an alumina, silica, titania, a clay or an aluminosilicate, the preferred base material is silica. This silica material is essentially inert. The particles will have a silica content by weight of about 20% to about 50%, preferably about 25% to about 40%. Alumina will be present in an amount of less than 2.5% and preferably less than about 1% by weight. The calcium content as calcium oxide is about 40% to about 60%, preferably about 45% to about 55%. The magnesium content as magnesium oxide is about 8% to about 20% and preferably about 10% to about 18%. The potassium content as potassium oxide is about 0.5% to about 2%. The content of other materials will individually be less that 2% by weight, and preferably less than 1%.

The ORP formulation will be comprised of particulate magnesium metal. The particulate magnesium should preferably have size of through a 2 to 6 mesh. Other sizes can be used but it may affect the flow through appliance unit. In purity the particulate magnesium must have a purity of at least about 99.5% and preferable about 99.8%. The impurities will be other metal ions. A preferred particulate magnesium is RMC-4/6 of the Reade Manufacturing Company located at 100 Ridgeway Boulevard, Manchester, N.J. This company also trade under the name Magnesium Elektron Powders.

### EXAMPLE

The base alkalizing material sample has the following formulation as percents by weight as follows: a silica content of 33.97%, alumina content of 0.53%; iron oxide content of 0.56%; a titania content of 0.01%; a calcium content of 49.91%, a magnesium content 13.98% and potassium content of 1.04%. Any other substances are in a content of less than 0.1%. This formulation is mixed with particulate magnesium metal. The alkalizing formulation will be comprised of about 80% of the base formulation and 20% by weight particulate magnesium metal as magnesium chips. The base alkalizing material is available from the Norpro Division of Saint-Gobain Norpro in Stow, Ohio. The magnesium metal is available from the Reade Manufacturing Company in Manchester, N.J.

A static test was conducted on the above formulation. 50 ml of alkalizing material formulation along with 200 ml of water is placed into a cup. The initial ph of the water was 7.05. The ph was measured at intervals. The ph and the intervals are as follows: 1 min. 9.99 ph; 5 min. 10.08 ph; 10 min. 10.08 ph; 30 min. 10.09 ph; 60 min. 10.12 ph; 24 hours 9.65 ph; 96 hours 9.73 ph; 120 hours 9.74 ph. After this 120 test interval the water was decanted from the formulation and 200 ml of fresh water added. After 30 sec. the ph was 8.98 and after 60 sec. the ph was 9.57. The data shows that the ph will be maintained above about 8 over a long period of time

In a dynamic test water at a ph of 7.0 was passed to through a media bed of 8 gms. at a flow rate of 3 ml/sec. After 1 minute the ph was 8.49. At a flow rate of 4 ml/sec the ph was 8.30 after 1 minute. At a flow rate of 5 ml/sec. the ph was 7.89 after 1 minute. In this test it is shown that the alkalizing formulation can maintain an alkaline output at increased rates of flow through the media.

This formulation can be effective for use in personal water bottles and other personal appliances. In order to use this formulation in other than personal appliances larger amounts will be required. In the combination with a purification formulation such purification formulations are available under the trademark AQUASPACE from Western Water International in Forestville, Md.

I claim:

1. An appliance for treating input water to increase the ORP of the input water comprising a housing, an input aperture for the input of water to the housing and an exit aperture for the flow of the input water from the housing, a formulation to decrease the ORP of the water to about −100 to about −700 within a first unit in the housing, the formulation comprising particulate magnesium metal.

2. An appliance for treating input water as in claim 1 wherein the formulation contains particulate magnesium metal having a nominal particle size of 0.5 inch in the major dimension to reduce the ORP.

3. An appliance for treating input water as in claim 2 wherein the particulate magnesium metal decreases the oxidation/reduction potential formulation to at least about −250 to about −400.

4. An appliance for treating input water as in claim 1 wherein connected to the first unit containing the ORP formulation, a second unit in the housing containing an alkaline formulation to increase the Ph of the input water at least 0.5.

5. An appliance for treating input water as in claim 4 wherein the alkaline formulation the calcium content is about 40% to 60% by weight of calcium ions in the form of their oxides and about 8% to about 20% by weight of magnesium ions in the form of their oxides.

6. An appliance for the treatment of input water as in claim 5 wherein the alkaline formulation is within a replaceable holder in the housing.

7. An appliance for the treatment of input water as in claim 1 wherein the unit is a straw, a dip tube extending from the lower input end of the unit and a straw segment extending from the exit end of the unit, whereby when a suction is applied to the straw segment water is drawn up through the dip tube into and through the housing and ORP treating formulation exiting into the straw segment.

8. An appliance for the treatment of input water as in claim 1 wherein the first unit is disposed over a container whereby input water is fed into the first unit, passed downwardly through the housing structure and the ORP treating formulation, and flowed into the container from the exit aperture of the first unit at a decreased ORP.

9. An appliance for the treatment of input water as in claim 1 wherein the first unit has an elongated structure with a water input end and a water output end, the ORP treating formulation having a first end adjacent the water input end and a second end adjacent the output end, the water passing longitudinally from the first end to the second end to raise the ORP of the water to about −100 to about −700.

10. An appliance for the treatment of input water as in claim 1 wherein the housing first unit has a holder for the ORP treating formulation, the holder being an elongated structure with an outer wall and an internal channel, the channel closed adjacent the input aperture of the housing, at least a portion of the outer wall having a plurality of pores to allow for the passage of water radially into the holder, into contact with the ORP treating formulation and into the internal channel to decrease the ORP of the water exiting the internal channel and the exit aperture of the first unit.

11. An appliance for the treatment of input water as in claim 1 wherein the first unit has two portions, a first portion contains a water purification formulation and the second portion contains the ORP treating formulation, the water purification part containing an activated carbon adsorbent.

12. An appliance for the treatment of input water as in claim 11 wherein the ORP formulation in the holder can treat a total volume of water of about 5 liters to about 10,000 liters.

13. An appliance for the treatment of input water as in claim 15 wherein the purification formulation and the ORP treating formulation are in a replaceable holder in the housing.

14. An appliance for the treatment of input water as in claim 11 wherein the unit is a straw, the straw having a first unit, a dip tube extending from the lower input end of the housing and a straw segment extending from the exit end of the housing, whereby when a suction is applied to the straw segment water is drawn up through the dip tube into and through the housing and the purification formulation and ORP treating formulation exiting from the straw segment at a decreased ORP.

15. An appliance for the treatment of input water as in claim 11 wherein the first unit is a disposed over a container whereby water is fed into the first unit and is passed downwardly through the purification formulation and the ORP formulation, and flowed into the container from the exit aperture of the first unit at a decreased ORP.

16. An appliance for the treatment of input water as in claim 11 wherein the first unit has an elongated structure with a water input end and a water output end, the purification formulation adjacent the input end, the ORP treating formulation adjacent the purification formulation, the exit from the ORP treating formulation adjacent the output end, the water passing longitudinally from the first end to the second end to decrease the ORP of the water.

17. An appliance for the treatment of input water as in claim 11 wherein the first unit has a holder for the purification formulation and the ORP treating formulation, the holder being an elongated structure with an outer wall and an internal channel, the channel closed adjacent the input aperture of the housing, at least a portion of the outer wall having a plurality of pores to allow for the passage of water radially into the holder and into contact with the purification formulation and the ORP treating formulation, and then into the internal channel to decrease the ORP of the water exiting the internal channel at the exit aperture of the first unit.
